(19) United States
(12) Patent Application Publication
(10) Pub. No.: US 2008/0027843 A1
(43) Pub. Date: Jan. 31, 2008

(54) Method and system for determining an optimum set of measures for the minimization of risks

(76) Inventors: Petra Johann, Grafing (DE); Francesco Montrone, Riemerling (DE); Ariane Sutor, Grafelfing (DE)

Correspondence Address: Siemens Corporation;Intellectual Property Department, 170 Wood Avenue South, Iselin, NJ, 08830, US

(21) Appl. No.: 11/495,953

(22) Filed: Jul. 28, 2006

(51) Int. Cl. G06Q 40/00

(52) U.S. Cl. 705/35

(57) ABSTRACT

System and method for determining an optimum set of measures which entails a minimization of risks while observing a predetermined budget (B), wherein, based on coherence components (Z) including possible combinations of measures (MK), each of which comprise a set (M) of measures (m), the associated costs (K) for implementing the set (M) of measures (m) and each of which comprise a utility value (W) for the profit achieved with the implementation of the set (M) of measures (m) to reduce the risks, that joined set (Mₒₚₜ) of measures (m) is calculated by joining sets (M) of measures from different coherence components (Z) the overall costs (K′) of which, calculated by adding the costs of the joined sets (M′), are smaller than the predetermined budget (B), and the overall utility value (W′) of which, calculated by adding the utility values (W) of the joined sets (M′), is a maximum, wherein, after a joining of sets (M) of measures (m), a joined set (M′) is then screened out if, at a lower overall utility value (W′), it shows higher costs (K′) than an already existing set (M) of measures (m).

### FIELD OF THE INVENTION

The invention relates to a system and a method for determining an optimum set of measures which entails a minimization of risks while observing a predetermined cost budget.

### BACKGROUND OF THE INVENTION

In quantitative risk analyses for technical systems and projects unidentified risks r can be evaluated, for example, on a monetary basis, especially in Euro. On the basis of the identified risks r measures m are derived to reduce the risks. However, the implementation of measures involves an expenditure which can likewise be evaluated, e.g. on a monetary basis. If the measures m are independent of each other, i.e. if they reduce different risks r, a risk analysis is relatively easy to perform by adding the costs K for the respective measures so as to determine the overall costs and, moreover, by adding the monetarily evaluated profits of the respective measures m, i.e. the achieved risk reduction. The optimum combination of measures is then that combination of measures the total costs of which range within the predetermined cost budget and which entails the largest overall profit.

In many real situations various measures m are dependent on each other, however, i.e. several measures m relate to one and the same risk r. As one measure m mostly reduces more than one risk r, it frequently happens that different measures m reduce the same risk r.

It is therefore the object of the present invention to provide a method and a system for determining an optimum set of measures, wherein a minimization of risks is achieved also with dependent measures while the predetermined cost budget B is observed.

### SUMMARY OF THE INVENTION

According to the present invention this object is achieved with a method comprising the features defined in the independent claims.

The invention provides for a method for determining an optimum set of measures which entails a minimization of risks while a predetermined cost budget B is observed, wherein, based on coherence components z including possible combinations of measures MK, each of which comprise a set M of measures m, the associated costs K for implementing the set M of measures m and each of which comprise a utility value W for the profit achieved with the implementation of the set M of measures m to reduce the risks, that joined set Mₒₚₜ of measures m is calculated by joining sets M of measures from different coherence components Z the overall costs K′ of which, calculated by adding the costs of the joined sets M′, are smaller than the predetermined cost budget B, and the overall utility value W′ of which, calculated by adding the utility values W of the joined sets M′, is a maximum.

In a preferred embodiment of the method according to the invention at least one risk r is reduced by each measure m from a combination of measures MK.

All risks r reduced by a measure m thereby form a risk group R.

In a preferred embodiment of the method according to the invention two measures mᵢ, mⱼ are dependent, if their respective risk groups Rᵢ, Rⱼ overlap in at least one risk r.

Vice versa, two measures according to the inventive method are independent, if the respective risk groups Rᵢ, Rⱼ do not overlap in a risk r.

According to one embodiment of the present invention the sets of measures m within one coherence component Z are dependent.

According to one embodiment of the present invention the sets M of measures m from different coherence components Z are independent.

According to one embodiment of the present invention the combinations of measures MK are preferably inputted and buffered in a memory.

In one embodiment of the method according to the present invention an associated risk group R is indicated for each measure m of a possible combination of measures MK.

The coherence component Z for the inputted combination of measures MK is thereby determined in dependence on the risk groups R of the set M of measures m indicated in the combination of measures.

In one embodiment of the method according to the invention the sets M of measures m of combinations of measures MK from different coherence components Z are independent of each other.

In one embodiment of the method according to the invention, at first, those combinations of measures are removed from the possible combinations of measures MK the costs K of which are higher than the predetermined cost budget B.

In one embodiment of the method according to the invention the remaining combinations of measures MK from the coherence component Z are sorted according to ascending costs.

In one embodiment of the method according to the invention that joined set M′ is screened out after a joining of sets M of measures m which, with a lower overall utility value W′, shows higher overall costs K′ than an already existing set of measures M.

The invention moreover provides for a system for determining an optimum set of measures which entails a minimization of risks while a predetermined cost budget B is observed, wherein, based on coherence components z including possible combinations of measures MK, each of which comprise a set M of measures m, the associated costs K for implementing the set M of measures m and each of which comprise a utility value W for the profit achieved with the implementation of the set M of measures m to reduce the risks, that joined set Mₒₚₜ of measures m is calculated by joining sets M of measures m from different coherence components Z the overall costs K′ of which, calculated by adding the costs of the joined sets M′, are smaller than the predetermined cost budget B, and the overall utility value W′ of which, calculated by adding the utility values W of the joined sets M′, is a maximum.

Preferred embodiments of the method and the system according to the invention for determining an optimum set of measures will be explained below with reference to the attached figures for explaining the essential features of the present invention.

### BRIEF DESCRIPTION OF THE DRAWINGS

FIG. 1: shows a first application example for explaining the inventive method for determining an optimum set of measures;

FIG. 2: shows a diagram for explaining the inventive method;

FIG. 3: shows a diagram for illustrating independent measures m for explaining the inventive method;

FIG. 4: shows a diagram for illustrating dependent measures m for explaining the inventive method;

FIGS. 5A, 5B: show diagrams for explaining risk groups of independent measures in the inventive method;

FIGS. 6A, 6B: show a diagram for illustrating risk groups of dependent measures in the inventive method;

FIG. 7: shows another application example for explaining the inventive method;

FIGS. 8A, 8B, 8C: show risk groups and coherence components for the application example shown in FIG. 7 for explaining the inventive method;

FIG. 9: shows a memory content as data base for implementing the inventive method;

FIG. 10: shows a block diagram of a possible embodiment of the inventive system for determining an optimum set of measures.

### DETAILED DESCRIPTION OF THE INVENTION

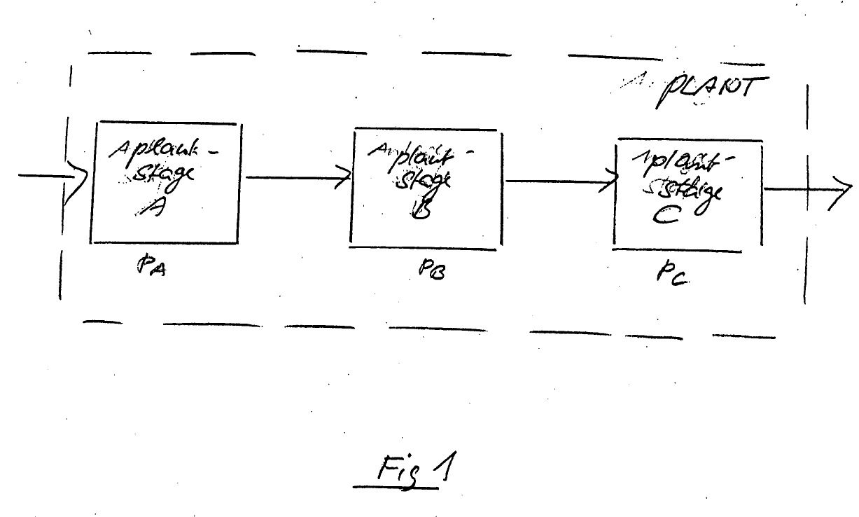

As can be seen in FIG. 1, a possible application example of the inventive method for determining an optimum set of measures is formed of a plant, e.g. a production plant, with several plant stages A, B, C. Each plant stage has a certain failure risk p which, due to the serial connection of the plant stages, entails a failure of the entire plant. The failure risk of the plant can be evaluated monetarily with a damage value, e.g. with a damage value of 100,000 EUR.

In order to minimize the risk of a failure of a production plant, for example, two different measures m₁, m₂ are available.

A first measure ml resides, for example, in maintaining each plant stage to an increased extent and in employing for this purpose, for example, additional staff.

The first plant stage A can, for example, be maintained to an increased extent, so that the failure risk pa of plant stage A is reduced to pa′.

The utility value for this measure, i.e. the achieved reduction of the damage or the risk, respectively, is calculated by

W1=(pa−pa′)·SE,

with SE being the damage in the event of a failure of the plant.

The costs for the increased maintenance can likewise be indicated, e.g. as labor costs for an additionally employed service assistant:

K₁=2,000 EUR.

An alternative measure m₂ resides, for example, in effecting an insurance against the failure of production stage A.

The utility value of this measure m₂ is:

W₂=p_{A}·SE.

The costs K₂ for this measure m₂ are the insurance premium, for example, of EUR 200.

K₂=200 EUR

The two measures m₁, m₂ can be implemented for each plant stage A, B, C so that a total of six different measures is possible in the given example, wherein the costs for maintenance and insurance of the different plant stages may deviate from each other.

As each measure m incurs costs and only a predetermined cost budget B is available, a decision has to be taken as to which combinations of measures come into consideration and which set of measures entails a minimization of the risks by observing the predetermined cost budget B. One possible set of measures may be, for example, to insure plant stage A, to maintain plant stage B to an increased extent and to do nothing with respect to plant stage C. The decision as to which combination of measures is the suitable one becomes even more difficult the more strongly the different measures m depend on each other.

One measure m is, for example, a technical measure, e.g. the additional connection of a monitoring function or the activation of actuators, sensors or units, or the deactivation thereof, respectively.

One measure could reside, for example, in insuring the entire plant, i.e. plant stages A, B, C together instead of separately so that the costs are, for example, 500 EUR and, thus, are lower as compared to a separate insurance in the amount of 3·200 EUR=600 EUR. If, in addition to insuring the entire plant, personnel for maintaining, for example, plant stage A is now employed, both measures, namely the measure of insuring the entire plant consisting of stages A, B, C, and the measure of an improved maintenance of plant stage A, jointly entail the reduction of the damage caused by the failure of plant stage A. Thus, these two measures m are dependent ones, as both of them have an effect on the same risk r.

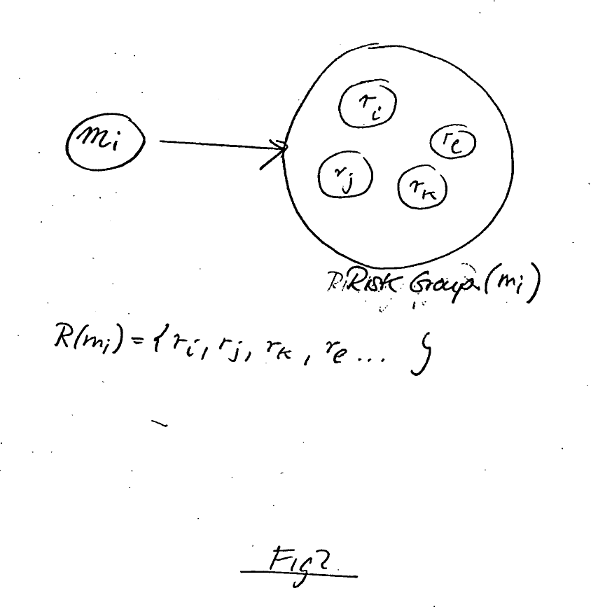

FIG. 2 shows a diagram for demonstrating the inventive method. According to this abstract diagram one measure mᵢ has effects on different risks r of a risk group R (mᵢ). Risk group R comprises all risks r reduced by the measure mᵢ.

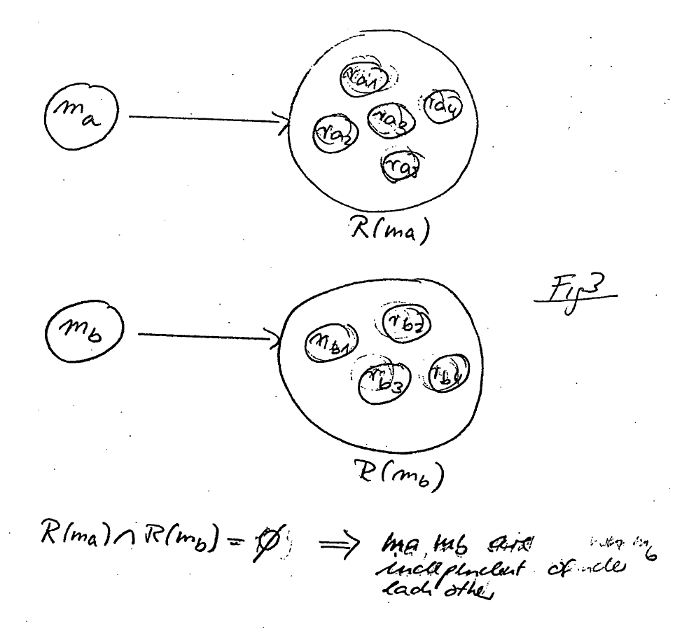

FIG. 3 shows another diagram of two independent measures mₐ, m_{b}. The two risk groups R (mₐ) and R (m_{b}) are not overlapping, i.e. there is no risk r on which the two measures mₐ, m_{b} have effects simultaneously during their implementation.

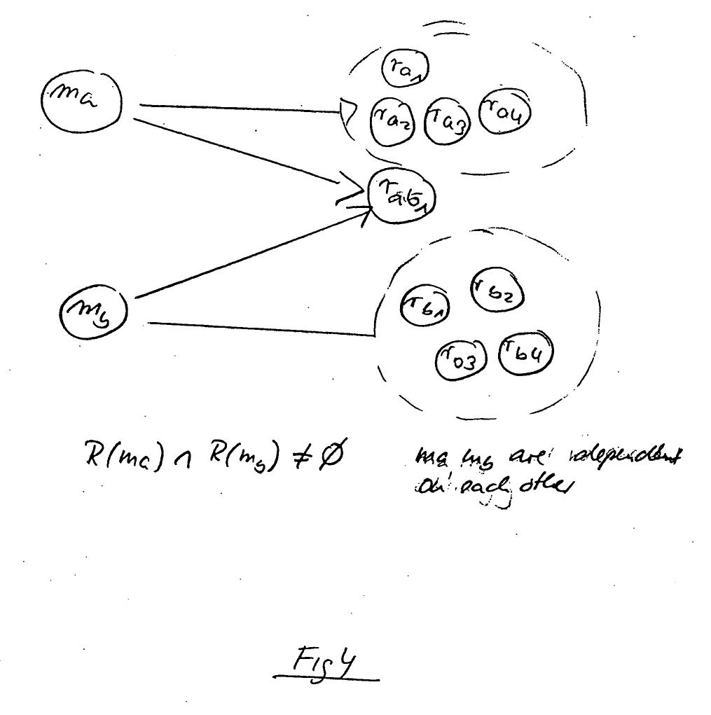

FIG. 4 shows another diagram of two dependent measures mₐ, m_{b}. In this example, both measure mₐ and measure m_{b} have effects on the risk r_{ab}, i.e. both measure mₐ and measure m_{b} reduce the risk r_{ab}, e.g. the failure of a plant stage of the plant illustrated in FIG. 1.

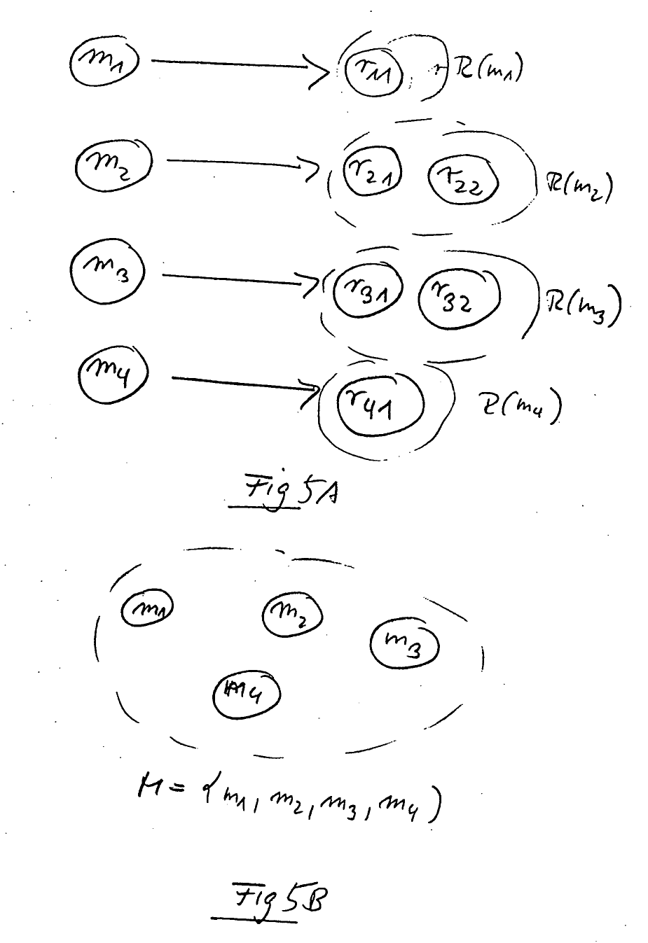

FIG. 5A shows another example of four measures m₁, m₂, m₃, m₄ independent of each other, with their associated risk groups R (m₁), R (m₂), R (m₃) and R (m₄).

FIG. 5B shows a pertinent measure graph of the set of measures M which consists of the four measures m₁, m₂, m₃, m₄ illustrated in FIG. 5A. As the risk groups of the different measures mⱼ are not overlapping or, respectively, are disjoint, no edges are drawn into the graph illustrated in FIG. 5B between the nodes formed by the measures m.

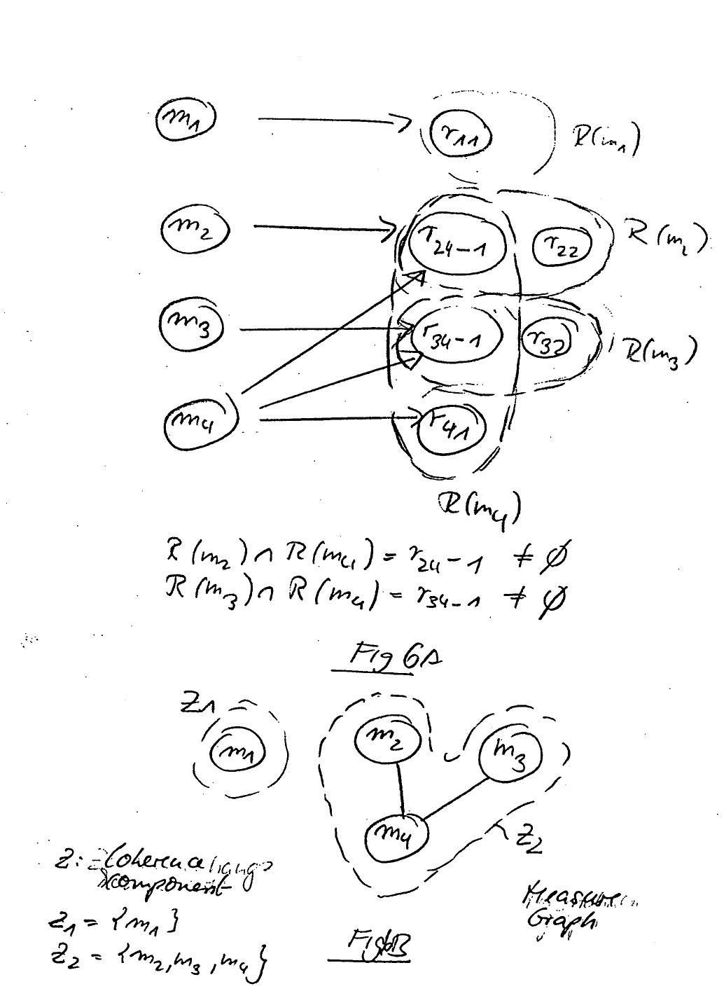

FIGS. 6A 6B show another example for dependent measures. In the example illustrated in FIG. 6A measure m₄ now also has effects on risks r in the risk groups R (m₂) and R (m₃), i.e. the risk group R (m₄) of measure m₄ and the risk groups R (m₂) and R (m₃) of measures m₂, m₃ overlap.

This results in the pertinent measure graph illustrated in FIG. 6B. Each measure mᵢ having an overlapping risk group R together with another measure mⱼ is connected in the graph by an edge to said other measure mⱼ. The measures m connected to each other by edges form a so-called coherence component Z. In the example illustrated in FIG. 6B a coherence component Z₁ consists of the isolated measure m₁ which is independent of the other measures.

A second coherence component Z₂ consists of measures m₂, m₃, m₄ which have overlapping risk groups R.

Two measures mᵢ, mⱼ are called directly dependent if they refer to the same risk r. A subset of all measures m is designated as coherence component Z if no measure m of the subset is directly dependent on a measure m outside the subset and if there exists a path of pairs of directly dependent measures for two measures of the subset, said path connecting the two measures. Two measures are called dependent if they are in the same coherence component Z.

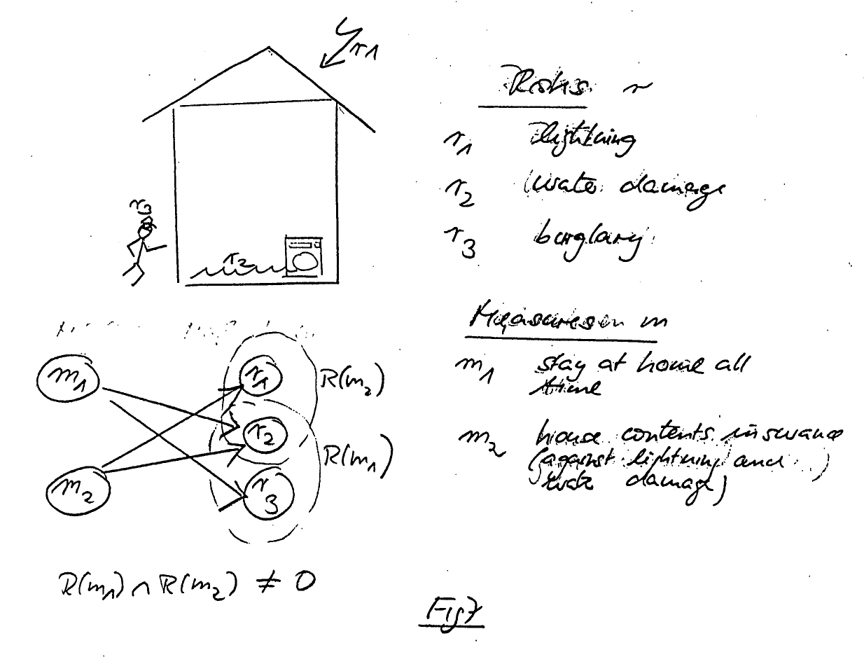

FIG. 7 shows another application example for explaining the inventive method.

In the application example an owner of a house has various risks r₁, r₂, r₃, namely a lightning stroke as risk r₁, a water damage as risk r₂ and burglary with the following theft of furnishings existing in the house as risk r₃.

A first possible measure m₁ taken by the owner to avoid a risk is to stay at home all the time. By this, burglars are deterred and risk r₃ is reduced. Moreover, the owner who stays at home may quickly discover a possibly damaged washing machine and reduce the risk r₂ of a water damage. However, in the given example, the owner is unable to minimize the risk r₃ of a lightning stroke, even if he stays at home.

Measure m₁ incurs costs, however. For example, opportunity costs are incurred, as the owner cannot go to work and does not receive any monthly income. Therefore, the costs' K_{A} for measure m₁ (stay at home all the time) amount, for example, to 2,000 EUR.

An alternative measure is to effect a home contents insurance insuring damages against lightning and water. By this, the risk for lightning r₁ and water damage r₂ can be reduced. However, the home contents insurance does not cover damages caused by burglary. The costs K₂ for such a home contents insurance amount, for example, to

200 EUR.

In the application example illustrated in FIG. 7 one thus obtains the following costs K for the different individual measures.

| Measure mᵢ | Costs K |
|---|---|
| m₁ (stay at home all the time) | K₁ = 2,000 EUR (monthly salary) |
| m₂ (house contents insurance) | K₂ = 200 EUR |

FIG. 7 moreover shows the relations between the risk groups R and the two measures m₁, m₂. As the two measures m₁, m₂ both have effects on the risk r2 (water damage), both measures m₁, m₂ are not independent of each other. For each risk r a probability p and a damage S caused by the same can be indicated.

For example, a lightning stroke r₁ results in the burning down of the house and in a relatively high damage of 10⁶=1 million EUR, wherein the probability is, for example, p1=10⁻³. The utility value for avoiding the damage caused by lightning stroke therefore amounts to 10⁻³·10⁶=1,000 EUR. The utility value for each individual risk r can be indicated in the same manner.

One obtains, for example, the following table:

r₁ (lightning)=p₁·S₁=10⁻³·10⁶ EUR=1,000 EUR

r₂ (water damage)=p₂·S₂=10⁻¹·10⁴ EUR=100 EUR

r₃ (theft)=p₃·S₃=10⁻²·10⁴ EUR=10 EUR

The owner of the house can now take different measure combinations. On the one hand, he can do nothing so that he incurs no costs, while no risk reduction is achieved, however.

If the owner takes measure ml he will have costs K₁ in the amount of 2,000 EUR and a risk reduction to a value of 110 EUR as a water damage r₂ and a theft r₃ of the furnishings are avoided.

If the owner takes measure m₂, i.e. effects a home contents insurance against lightning and water damages, he will have costs K₂ in the amount of 200 EUR and a risk reduction to a value of 1,100 EUR as both the damages caused by lightning r₁ and by water r₂ are covered.

If the owner takes both measures m₁, m₂, i.e. if he stays at home all the time and additionally effects a home contents insurance, he has costs in the amount of 2,200 EUR and a risk reduction to a value of 1,100 EUR.

The house owner is now confronted with the question as to which combination of measures or which set of measures M, respectively, he should take. The following sets of measures are available:

M₁={−}

M₂={m₁}

M₃={m₂}

M₄={m₁, m₂}

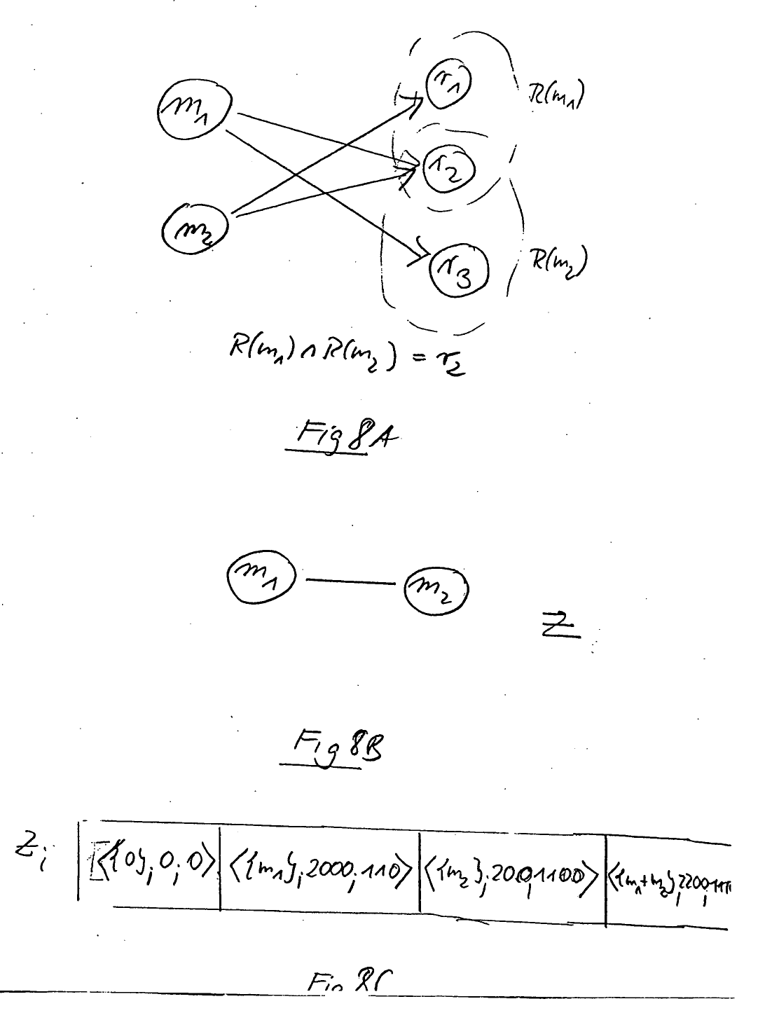

FIG. 8A shows the connection between measures m₁, m₂ to be taken and the risks r₁, r₂, r₃ thereby reduced. As the two risk groups R for measures m₁, m₂ are overlapping, the two measures m₁, m₂ are not independent of each other. Both measures m₁, m₂ entail a reduction of risk r₂, i.e. both the staying at home and the conclusion of an insurance contract for a home contents insurance reduce the risk of a water damage in the amount of a utility value of 100 EUR.

FIG. 8B shows the pertinent measure graph, in which the two non-independent measures m₁, m₂ are connected to each other by an edge and form a coherence component Z.

FIG. 8C shows a corresponding coherence component Z consisting of several possible combinations of measures MK. Each combination of measures MK is a value triple indicating a set M of measures m, on the one hand, and the associated costs K for implementing all measures m of the set M and the thereby obtained utility value W for the implementation of all measures m of set M.

In the example shown in FIG. 8C the first combination of measures MK₁ comprises an empty set m of measures, which do not incur any costs or yield a utility value. The second combination of measures MK₂ comprises a set of measures M₂, which merely comprises measure ml at a cost of 2,000 EUR and a profit gain of 110 EUR. The third combination of measures MK₃ comprises the set of measures M3 with measure m₂, i.e. the house contents insurance, at a cost value of 200 EUR and a profit of 1,100 EUR. The fourth combination of measures MK₄ comprises the set of measures M₄ with both measures m₁, m₂, an expenditure of 2,200 EUR and a risk reduction to a value of 1,100 EUR.

| | Costs for said | Value of this combination |
|---|---|---|
| Set of Measures M | Measures | of measures |
| M₁ = Ø (do | Ø | Ø |
| nothing) | | |
| M₂ = {m₁} | K₁ = 2,000 EUR | r₂ + r₃ = 110 EUR |
| M₃ = {m₂} | K₂ = 200 EUR | r₁ + r₂ = 1,100 EUR |
| M₃ = {m₁ + m₂} | K₁ + K₂ = 2,200 | r₁ + r₂ + r₃ = 1,110 EUR |
| | EUR | |

Complicated decision combinations may result in a plurality of coherence components Z each consisting of a group of combinations of measures MK, wherein each combination of measures consists of one set M of measures, an associated cost value K and an associated utility value W.

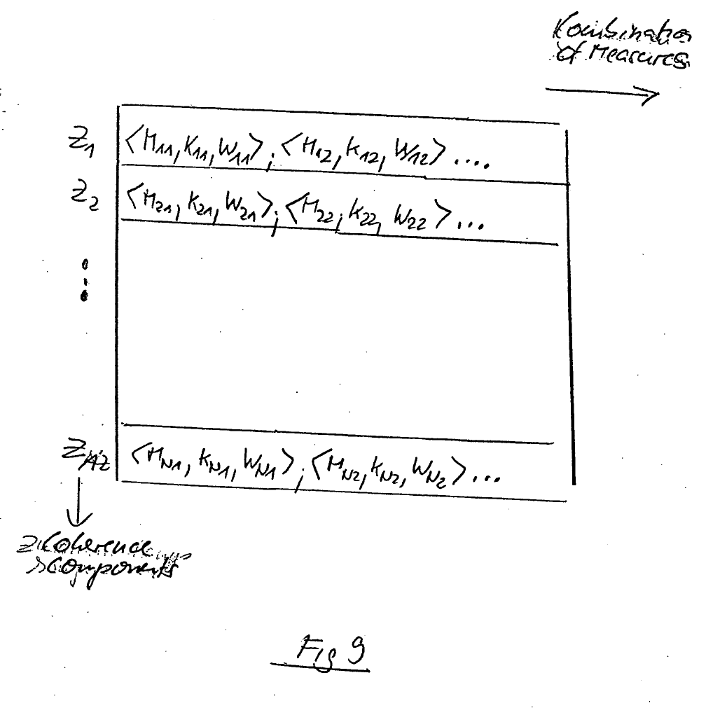

FIG. 9 shows the possible stored content of a memory as a data base for the inventive method for determining an optimum set of measures for observing a predetermined cost budget b.

Due to a predetermined cost budget B there is, as a rule, no possibility to take all combinations of measures into consideration. In the application example shown in FIG. 7, for example, the combination of measures MK₄, which comprises the set of measures M₄, is the most expensive combination of measures at a cost of 2,200 EUR. If the maximum budget B of the house owner is 2,100 EUR this combination is out of the question, even if it yields the highest profit.

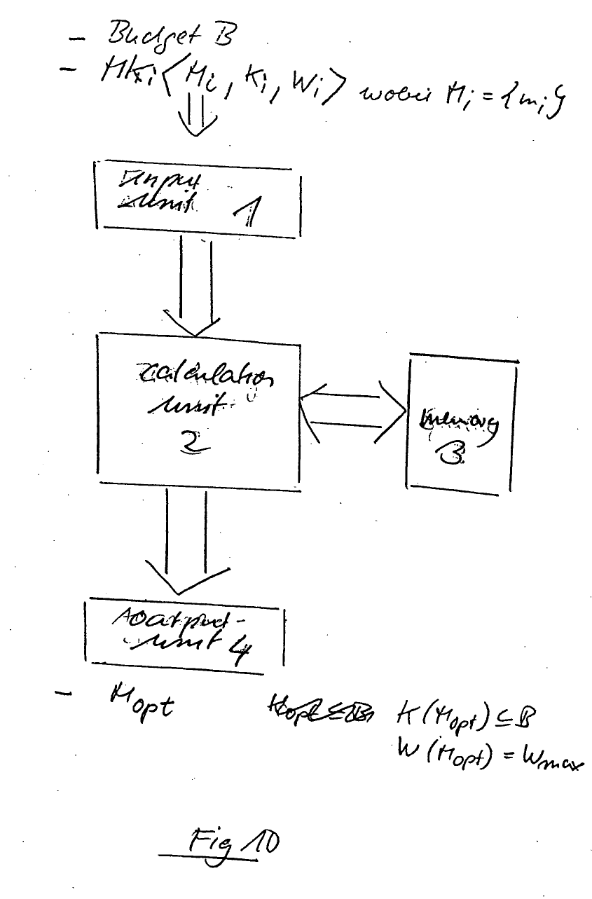

FIG. 10 shows a block diagram for explaining the inventive system for determining an optimum measure Mₒₚₜ.

The available cost budget B is read in via an input unit or interface 1, respectively. Further, the possible combinations of measures MK with the corresponding set of measures M and the associated costs K and the utility values W of the set of measures M are read in. The read-in combinations of measures MK are buffered in a memory 3 by means of a calculation unit 2, said memory 3 having, for example, the memory content shown in FIG. 9. On the basis of the data base stored in memory 3 the calculation unit 2 calculates by means of the inventive method an optimum set of measures Mₒₚₜ and reads it out by means of an output unit 4 or an interface 4, respectively. The optimum set of measures Mₒₚₜ shows costs which are lower than the available cost budget B and simultaneously has a maximum utility value Wₘₐₓ, i.e. the value of the obtained risk reduction is a maximum.

Various coherence components Z are stored in memory 3, with A₂ constituting the number of the coherence components Z.

The calculation unit 2 calculates on the basis of the coherence components Z, by joining sets M of measures m from different coherence components Z, that joined set M of measures m the overall costs of which, which are calculated by adding the costs of the joined sets M′, are lower than the predetermined cost budget and the total utility value W′ of which, which is calculated by adding the utility values W of the joined sets M′, is a maximum.

As the combinations of measures or sets of measures, respectively, from the different coherence components Z are independent, they can be combined by joining the sets of measures M and by respectively adding the costs K and the utility values W. All combinations of measures from all coherence components Z are added, which do not yet contain a measure from the previous coherence components Z. The useful newly created combinations of measures MK are buffered and sorted. Combinations of measures or sets of measures, respectively, causing higher costs K as compared to another set of measures, with a lower utility value, are removed.

In one possible embodiment of the inventive method, at first, those combinations of measures MK are removed from the possible ones the costs K of which are higher than the predetermined cost budget B.

The remaining combinations of measures MK in one coherence component Z are then sorted according to ascending costs K.

After each joining of sets M and measures m a joined set M′ is screened out if, at a lower total utility value G′, its total costs K′ are higher than those of an already existing set M or, respectively, already existing joined sets M′ of measures m.

A possible embodiment of the inventive method for determining an optimum combination of measures which entails a minimization of risks while observing a predetermined cost budget B is represented below in the form of a pseudo-code:

Definition of a combination of measures:

```
struct measure combi (
                {set of measures},
    costs of these measures,
          value of these measures)
```

Input:
A_{z}=number of the coherence components Z
vector<list<measure combi>cohCombis//cohCombis [i] contain the list of all possible nonempty combinations of measures of the i-th coherence-component Z(i). These are 2^{(z(1))}−1 combinations.
budget B

Output: Optimum combinations of measures, i.e. set of measures m the costs of which do not exceed the budget B and the value of which is maemal under this condition.

Core algorithm for determining the optimum combination of measures:

```
For i = 1, ..., A_{Z}
  For each combi ε cohCombis [i]
          If (combi. costs > B)
            delete combi;
        End For
cohCombis [i] . sort (costs); // sort according to ascending costs
      For each combi ε cohCombis [i]
          // determined measure combi
with next higher costs as com
          // bi. If this one has no
greater value than combi, it will be
          // deleted.
          Measure combi NextCombi =
CohCombis [i] . Successor (Combi);
          If (Combi. Value≧
NextCombi.Value)
            delete NextCombi;
        End For
End For
// CohCombis [i] now still only contains those combinations of measures
from
// Z (i), the costs of which do not exceed the budget and the value of
which is not
// smaller than the value of a less costly combination of measures from
// Z(i).
A_{MK} = Number of combinations of measures in cohCombis
vector <measure combi> AllCombis;
AllCombis.pushback ( (emptySet,0,0) );
// In AllCombis all candidates for the optimum solution are stored in a
manner sorted
// according to ascending costs. These are combinations of measures $$
posed of
// combinations of measures from different coheence components. As combinations
// of measures from different coherence components are independent, we
can
// combine them by joining the sets of measures and by adding the
// the costs and values.
// Now all combinations of measures from all coherencecomponents
// Z(i) are added to the combinations of measures in AllCombis, which do
not
// yet contain measures from Z(i). The useful newly created combinations
of
// measures are at first stored in NewCombi and are sorted into AllCombis
later.
// AllCombis is thereby “tidied up” at all times, i.e. combinations of
measures incurring
// higher costs than another measure in AllCombis, with a lower value,
are
// removed.
For i = 1, ..., A_{Z}
  For j = 1, ..., CohCombis [i] . size ( )
  // Determining new combinations of measures which are then stored
in new
  // combis.
  vector<measurescombi> NewCombis;
  For q=1, ..., AllCombis.size ( )
    If (AllCombis [q].measures already contains measures
        from Z(i))
            break (q); // Co-
herent measures were
              // already
examined. Therefore, consider
              // next
        measure from AllCombis.
Measures_{new} = AllCombis [q] .
      measures CohCombis
[i] [j]. measures;
            costs_{new} = AllCombis
[q] . costs + CohCombis
          [i] [j]. costs;
    value_{new} = AllCombis [q] . value+ CohCombis [i]
  [j] . value;
combi = new measures
combi (measures_{new} , costs_{new},
        value_{new});
            If (costs_{new} ≦ B)
              NewCombis
.push_back (Combi);
          End For
          // Sorting in the new combinations
of measures in AllCom
          // bis and “tidying up”
AllCombis.
          For each Combi ε NewCombis
            AllCombis.insert
(Combi) at position k
              with AllCombis
[k−1]. Costs <= Combi.Costs < AllCombis
[k+1]. Costs;
            If ( AllCombis [k−
1]. Value >= Combi.Value)
              delete
AllCombis [k];
              Else If
(Combi.Costs = AllCombis[k−1]. Costs )
              delete
AllCombis [k−1];
          End for each
        End For
End for
Optimum = AllCombis [AllCombis.size ( ) ];
// Last element of AllCombis is optimum.
```

According to the inventive method the measures m, their dependency and their utility values with respect to the risk reduction as well as the existing cost budget B are inputted. For directly dependent measures a utility value for each combination or set M of these measures m, respectively, is additionally inputted.

Within one coherence component Z all combinations of measures MK are considered. With the combination with measures from other coherence components Z it is, according to the inventive method, sufficient, however, to consider only the most attractive combinations of measures MK from the respective coherence component Z. According to the inventive method initially all combinations of measures MK are examined for each coherence component Z of measures m, and the most attractive combinations of measures are buffered. Next, the stored combinations from the coherence components Z and the independent individual measures are considered. Combinations of measures from identical coherence components Z are thereby not examined again.

With coherent measures all combinations of measures MK are considered, wherein those that have finally proved to be worse at higher costs are discarded. Next, all combinations of measures MK between combinations from coherence components Z and independent individual measures are examined. As the new combinations of measure are independent among each other, it is sufficient to proceed only with the most attractive ones.

For a given budget B the method according to the invention provides for such a combination of measures or set of measures M, respectively, which includes the largest possible risk reduction. According to the inventive method a qualified decision for the implementation of measures m can be taken in a secured manner. The decision thereby falls on the optimum combination of measures Mₒₚₜ. Thus, intuitive decisions are avoided.

The method according to the invention is particularly suitable for risk analyses with respect to technical systems and projects. The method according to the invention is not limited to this, however, but may be applied in all fields of life which are subject to risks.

We claim:

1. A method for determining an optimum set of measures which entails a minimization of risks while observing a predetermined budget, comprising:
providing a plurality of coherence components that comprise a set of cost measures and a utility value for profit that is achieved via implementing the set of cost measures;
calculating a joined set of measures by joining sets of measures from the plurality of coherence components;
calculating overall costs by adding the costs of the joined sets that are smaller than a predetermined budget;
obtaining an overall utility value that is calculated by adding utility values of the joined sets that are a maximum; and
deleting a joined set after joining the sets of measures if, at a lower overall utility value, costs that are higher than an already existing set of measures are indicated.

2. The method according to claim 1, wherein each measure of a combination of measures reduces at least one risk.

3. The method according to claim 2, wherein all risks reduced by a measure form a risk group.

4. The method according to claim 3, wherein two measures are dependent if the two risk groups overlap in at least one risk.

5. The method according to claim 3, wherein two measures are independent if their two risk groups do not overlap.

6. The method according to claim 4, wherein the sets of measures within one coherence component are dependent.

7. The method according to claim 6, wherein the sets of measures from different coherence components are independent.

8. The method according to claim 1, wherein the combinations of measures are inputted and buffered.

9. The method according to claim 1, wherein an associated risk group is indicated for each measure of a possible combination of measures.

10. The method according to claim 9, wherein the coherence components for the measures are determined in dependence on the risk groups of the measures contained in the measures.

11. The method according to claim 10, wherein the sets of measures of combinations of measures from different coherence components are independent of each other.

12. The method according to claim 1, wherein, at first, the combinations of measures are removed from the possible combinations of measures the costs of which are higher than the predetermined budget.

13. The method according to claim 12, wherein the remaining combinations of measures from the coherence components are sorted according to ascending costs.

14. A method for determining an optimum set of measures which entails a minimization of risks while observing a predetermined budget (B), comprising:
wherein, based on coherence components (Z) including possible combinations of measures (MK), each of which comprises a set (M) of measures (m), the associated costs (K) for implementing the set (M) of measures (m) and each of which comprise a utility value (W) for the profit achieved with the implementation of the set (M) of measures (m) to reduce the risks, that joined set (Mₒₚₜ) of measures (m) is calculated by joining sets (M) of measures from different coherence components (Z) the overall costs (K′) of which, calculated by adding the costs of the joined sets (M′), are smaller than the predetermined budget (B), and the overall utility value (W′) of which, calculated by adding the utility values (W) of the joined sets (M′), is a maximum,
wherein, after a joining of sets (M) of measures (m), a joined set (M′) is then deleted out if, at a lower overall utility value (W′), it shows higher costs (K′) than an already existing set (M) of measures (m).

15. The method of claim 13, wherein the method is used with a computerized quantitative risk analysis system.
